(19) United States
(12) Patent Application Publication
(10) Pub. No.: US 2006/0237556 A1
(43) Pub. Date: Oct. 26, 2006

(54) System and method for monitoring performance of a spraying device

(75) Inventors: Lieven Wulteputte, Melle (BE); Herman Ramon, Gent (BE); Jan Anthonis, Haasrode (BE); Bart De Ketelaere, Heverlee (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Spraying Systems Co., Wheaton, IL (US)

(21) Appl. No.: 11/114,443

(22) Filed: Apr. 26, 2005

(51) Int. Cl. B67D 5/08

(52) U.S. Cl. 239/71; 239/74

(57) ABSTRACT

A spraying device that sprays of a mixture of fluids is monitored to determine whether it is functioning properly. The spraying device has inlets for at least two fluids, such as water and air, and a mixing chamber in which the fluids are mixed. A mixture pressure sensor is mounted on the spraying device to detect the pressure of the mixture. The input pressures of the fluids entering the spraying device are also measured. The measured input pressures of the fluids are used to calculate a predicted mixture pressure based on an empirical formula, which has parameters that can be derived when the spraying device is installed in its operating position. The calculated pressure value and the measured actual mixture pressure are then used in a comparison process to determine whether or not the spraying device is functioning properly.

### FIELD OF THE INVENTION

The invention concerns spraying devices such as nozzles, and more particularly to a system and method for monitoring the performance of a spraying device.

### BACKGROUND OF THE INVENTION

Spraying devices such as nozzles are widely used in a variety of industrial applications. In many applications, the proper performance of spraying devices is critical to the processing in which the sprays are used. The failure of a spraying device may result in defective products and cause potentially significant economic losses.

For instance, in the steel industry, spray nozzles of an internal-mixing type are used for steel cooling in a continuous casting process. An internal-mixing nozzle used in such a casting application provides a spray of a mixture of water and air, i.e., a mist. To that end, the spray nozzle has an internal mixing chamber, and water and air inlets with calibrated orifices. Water and air are fed through the inlet orifices into the internal mixing chamber, where they are mixed. The mixture is transported through a tube to a nozzle aperture that discharges the mixture in a desired spray pattern, such as a flat pattern. The spray generated by the nozzle is a function of the input water and air pressures, which may be set at different values for different applications depending on the particular requirements of the applications. For the nozzle to function properly, the input air and pressures have to be tightly controlled. Doing so, however, is not sufficient to guarantee the proper operation of the nozzle, because the air and water inlet orifices and the nozzle tip may become worn due to use or clogged, thereby preventing the nozzle from generating the desired spray output. Such performance degradation or malfunction of the internal-mixing spray nozzles can develop gradually overtime and has been difficult to monitor or detect.

### SUMMARY OF THE INVENTION

In view of the foregoing, it is an object of the invention to provide a reliable way to effectively monitor the performance of a spraying device, especially an internal-mixing spray nozzle, to ensure that it is functioning properly over the course of usage.

It is a related object to detect any significant performance degradation or malfunction of a spraying device, such as an internal-mixing spray nozzle, so that spraying device can be repaired or replaced promptly to minimize any potential economic losses.

These objects are effectively addressed by the system and method of the invention for monitoring the performance of a spraying device. The spraying device has at least a first inlet for receiving a first fluid and a second inlet for receiving a second fluid. The spraying device further includes an internal mixing chamber whether the first and second fluids are mixed. The mixture is transported from the mixing chamber to a nozzle aperture, which discharges the mixture to form a spray.

In accordance with the invention, a mixture pressure sensor is disposed on the spraying device downstream of the mixing chamber to detect the pressure of the mixture. The input pressures of the first and second fluids entering the spraying device are also measured. The measured pressures of the first and second fluids are used to calculate a predicted mixture pressure based on an empirical formula. The calculated value and the measured value of the mixture pressure are then used in a comparison process to determine whether or not the spraying device is functioning properly.

Additional features and advantages are explained in more detail below with the aid of preferred embodiments shown in the drawings, of which:

### BRIEF DESCRIPTION OF THE DRAWINGS

FIG. 1 is a schematic view of an embodiment of a spraying system in which the performance of an internal-mixing spraying device is monitored by a controller;

FIG. 2 is a cross-sectional top view of the spraying device in FIG. 1;

FIG. 3 is a cross-sectional side view of the spraying device with a mixture pressure sensor mounted thereon; and

FIG. 4 is a flowchart showing a process of setting up and operating the system for monitoring the performance of the spraying device.

### DETAILED DESCRIPTION OF THE EMBODIMENTS

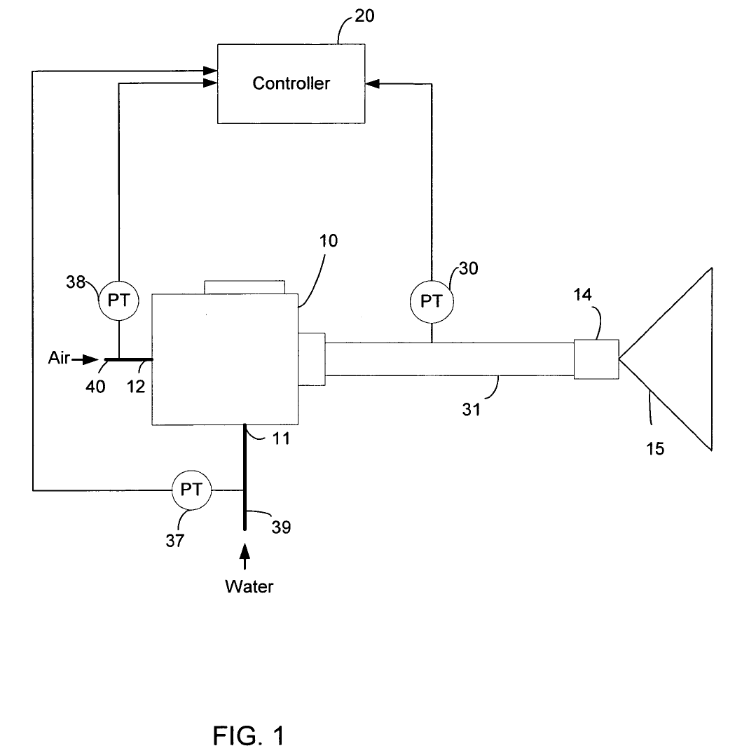

The present invention provides a system and method for monitoring the performance of a spraying device that receives different fluids and generates a spray of a mixture of the fluids in a given spray pattern. FIG. 1 shows an embodiment of such a spraying system, which includes a spraying device 10 and a controller 20 that monitors the performance of the spraying device in a way that will be described in greater detail below.

The spraying device 10 as shown in FIG. 1 has a first inlet 11 for a first fluid to enter the spraying device, and a second inlet 12 for a second fluid to enter the device. The two fluids are formed into a mixture inside the spraying device, and the mixture is ejected from an output nozzle end 14 of the spraying device in the form of a spray 15 with a desired spray pattern. The spraying device 10 may be used, for example, in a metal casting operation for providing cooling to the cast product, and in such an application the first and second fluids may be water and air, respectively. Even though the spraying device of the illustrated embodiment has two fluid inlets, it will be appreciated that more inlets can be added for applications where additional types of fluids are to be included in the mixture, and that the invention may be used to monitor the operation of a spraying device with three or more fluid inlets.

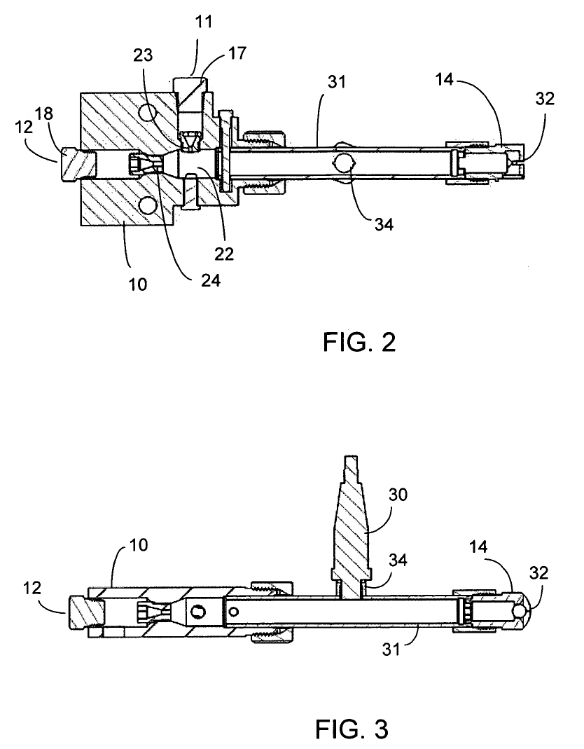

Referring to FIG. 2, the inlets 11, 12 are provided with fittings or connectors 17, 18 to receive pipes carrying the fluids. Inside the spraying device 10 is a mixing chamber 22. The first inlet 11 is in fluid communication with the mixing chamber 22 via a first orifice 23, and similarly the second inlet 12 is connected to the mixing chamber 22 via a second orifice 24. The first and second orifices are used to meter the flow of the fluids into the mixing chamber and preferably are calibrated so that the relationship between the flow rate of each fluid into the spraying device and the fluid pressure is well understood. The first and second fluids entering the inlets 11, 12 flow through the respective orifices 23, 24 and are merged in the mixing chamber 22, where they form a mixture, and the ratio of the fluids in the mixture is determined by the flow rates of the fluids into the nozzle. The mixture is carried by a tube 31 from the mixing chamber 22 to the nozzle end 14, where the mixture is discharged through a nozzle aperture 32 to form the spray.

In accordance with a feature of the invention, a pressure sensor 30 for sensing the pressure of the mixture formed in the spraying device 10 is disposed directly on the spraying device 10 to allow accurate measurements of the pressure. To that end, in the embodiment shown in FIG. 2, a port 34 is provided on the tube 31 connecting the mixing chamber to the nozzle aperture. The port 34 is configured to receive the pressure sensor 30, as shown in FIG. 3. Alternatively, the pressure sensor 30 may be mounted on the body of the spraying device 10 such that the pressure sensor is in direct fluid communication with the mixing chamber 22. The pressure sensor 30 is selected to be able to withstand the pressure of the mixture in the spraying device and to have a sufficient sensitivity to enable accurate readings of the mixture pressure. A suitable pressure sensor may be, for example, the Model OT-1 pressure transmitter made by WIKA Alexander Wiegand GmbH & Co. KG in Klingenberg, Germany.

Returning to FIG. 1, to provide readings of the pressures of the first and second fluids flowing into the spraying device 10, pressure sensors 37, 38 are provided in the pipe lines 39, 40 feeding the fluids to the spraying device 10. The pressure sensors 37, 38 preferably are located close to the inlets 11, 12 so their readings reflect accurately the pressure values of the fluids entering the spraying device. The three pressure sensors 37, 38, 30 are connected to the controller 20 such that the controller receives output signals of the pressure sensors, which represent the measured pressures of the first and second fluids and the mixture in the spraying device, respectively.

In accordance with a feature of the invention, the performance of the spraying device 10 is monitored by the controller 20 by comparing the measured actual pressure value of the mixture with a predicted mixture pressure, which is calculated using the measured pressures of the fluids as inputs. The predicted mixture pressure is calculated using an empirical formula that describes the relationship between the expected mixture pressure and the input pressures of the fluids. The exact form or shape of the formula can be determined/selected based on an understanding of the fluid dynamics involved and by finding a best fit of measured data with the formula.

By way of example, in one embodiment, the following formula with several linear parameters is used to predict the mixture pressure:
Pₘᵢₓ=b₁+b₂·Pₐᵢᵣ+b₃·P_{water}^{x}+b₄·Pₐᵢᵣ·P_{water}^{x} (Equation 1)
In this formula, Pₐᵢᵣ is the measured pressure for the air, P_{water} is the measured pressure for the water, and Pₘᵢₓ is the predicted pressure of the mixture in the spraying device. This formula contains four linear parameters b1, b2, b3, and b4, which are to be determined empirically. The exponent x is a fixed number, such as 0.5. It has been found that this formula provides a reasonably good model for predicting the mixture pressure based on given input fluid pressures. It will be appreciated, however, that this formula is only one of different forms of equations that may be used, and the invention is not limited to the particular form of this formula. Also, although the use of a linear formula has the advantage of computational efficiency, non-linear equations may also be used to model the mixing behavior of the spraying device if such a formula can more accurately predict the mixture pressure and if the controller has sufficient computational power to carry out calculations involved in handling the non-linear equations.

In accordance with an aspect of the invention, the parameters in the formula in Equation 1 for calculating the mixture pressure can be learned by the controller 20 when the spraying device is “on-line,” i.e., installed in its intended operating position. In the learning process, the input pressures of the fluids are varied, and the measured values of the pressures of the first and second fluids and the mixture are used as inputs for determining the parameters. This learning operation is preferably performed when the spraying device is first put in service, under the assumption that the nozzle is performing correctly as designed during this phase. Once the parameters of the formula for predicting the mixture pressure are determined in this learning phase, they can be used by the controller 20 in the subsequent operations of the spraying device to calculate the expected mixture pressure based on measured input pressures of the fluids. The expected mixture pressure value can then be used with the measured actual mixture pressure in a comparison process to determine whether the spraying device is operating properly.

In one embodiment, the learning of the parameters of the empirical formula is done via a recursive least square parameter estimation algorithm, as set forth in the following equations:

$$\hat{θ} ( t ) = \hat{θ} ( t - 1 ) + K ( t ) ( y ( t ) - \hat{y} ( t ) )$$

$$\hat{y} ( t ) = {ψ}^{T} ( t ) \hat{θ} ( t - 1 )$$

$$K ( t ) = Q ( t ) ψ ( t )$$

$$Q ( t ) = P ( t ) = \frac{P ( t - 1 )}{λ + {ψ ( t )}^{T} P ( t - 1 ) ψ ( t )}$$

$$P ( t ) = \frac{1}{λ} ( P ( t - 1 ) - \frac{P ( t - 1 ) ψ ( t ) {ψ ( t )}^{T} P ( t - 1 )}{λ + {ψ ( t )}^{T} P ( t - 1 ) ψ ( t )} )$$

where y(t)=measured mixture pressure at the moment t;

ŷ(t)=prediction of measured mixture pressure at the moment t based on information before the moment t;

P(t)=inverse covariance matrix;

ψ(t)=input values (input measurements, air and water pressure)

θ(t)=parameter vector (b1, b2, b3, b4)

λ=forgetting factor (=1)

After the parameters in the mixture pressure formula are determined using the recursive least square algorithm, the formula is ready to be used by the controller 20 for monitoring the performance of the spraying device. When the controller 20 detects a significant deviation of the measured mixture pressure in the spraying device from the predicted or expected mixture pressure and if the deviation lasts for a sufficiently long time, it generates a fault signal to get the attention of the operator of the processing line so that the possible cause of the deviation can be investigated, and the spraying device may be repaired or replaced if necessary.

In one embodiment, a combination of static and dynamic techniques is used to determine if a fault signal should be generated. In this fault determination process, measurements are taken periodically at regular intervals. For each measurement interval, a static error state Sᵢ at a certain moment in time (tᵢ) is calculated as follows:
Pₘₘᵢ: measured mixed pressure at time i
P_{abs}: maximum absolute error
Eᵣₑₗ: maximum relative error (in %)
Absolute fault: Pₑᵣᵣ_{ᵢ}=Pₘᵢₓ_{ᵢ}−Pₘₘ_{ᵢ}
Relative fault 1: Pᵣ₁_{ᵢ}=Pₘᵢₓ_{ᵢ}·Eᵣₑₗ
Relative fault 2: Pᵣ₂_{ᵢ}=Pₘₘ_{ᵢ}·Eᵣₑₗ
   The error state at time tᵢ is: Sᵢ=(|Pₑᵣᵣ_{ᵢ}|>P_{abs})+(|Pₑᵣᵣ_{ᵢ}|>Pᵣ₁_{ᵢ})+(|Pₑᵣᵣ_{ᵢ}|>Pᵣ₂_{ᵢ}).

Thus, the static error state Sᵢ is determined based on three threshold levels: a pre-selected fixed level P_{abs}, and two variable levels Pᵣ₁ᵢ and Pᵣ₂ᵢ that depend on the values of the measured input liquid pressures. The values of P_{abs} and Eᵣₑₗ are chosen depending on the accuracy of the sensors and the stability of the signals. A good choice for P_{abs} is, for example, 3 times the standard deviation on Pₑᵣᵣ, measured on a large number of points (e.g. 1000) in the normal operating range of the nozzle. In that case, the P_{abs} is calculated based on the following equations:

$${P}_{abs} = 3 \cdot \sqrt{{\sum }_{i = 0}^{i = n - 1} \frac{{( {P}_{{err}_{i}} - μ )}^{2}}{n}}$$

$$μ = {\sum }_{i = 0}^{i = n - 1} \frac{{P}_{{err}_{i}}}{n}$$

The type of error causing the pressure deviation depends on the sign of Pₑᵣᵣ. If the sign is positive, the measured actual pressure is lower than the predicted pressure. This may happen if either the calibrated orifices are blocked or the tip is worn out. On the other hand, if the sign is negative, the measured pressure is higher than the predicted pressure, which may occur if either the calibrated orifices are worn out or the tip is blocked. Thus, based on the sign of Pₑᵣᵣ, the possible cause of the pressure deviation can be determined.

The dynamic error state (Dᵢ) is then calculated using the following algorithm:
If _{Sign(P}_{ₑᵣᵣᵢ}_{)≠Sign(P}_{_{err−1}}₎, then Dᵢ is false (valid situation).
If Sᵢ is false for at least T_{good}, then Dᵢ is false (valid situation).
If Sᵢ is true for at least T_{bad}, then Dᵢ is true (fault detected).
   In this determination, Dᵢ is set to be true only when the static error state Sᵢ has been true for a pre-selected time period T_{bad}. This is done to reduce the likelihood that the measured pressure deviation is caused by noise or fluctuation in the liquid pressures or the sensed pressure signals. If the dynamic error state Dᵢ is true, the controller 20 determines that a fault situation is found, and generates a fault signal to indicate that the spraying device is not functioning properly.

The following factors using in the decisions above have to be chosen, and are depending on the dynamics of the system:
T_{good}: time needed with good samples before the situation is evaluated as valid
T_{bad}: time needed with bad samples before the situation is evaluated as faulty

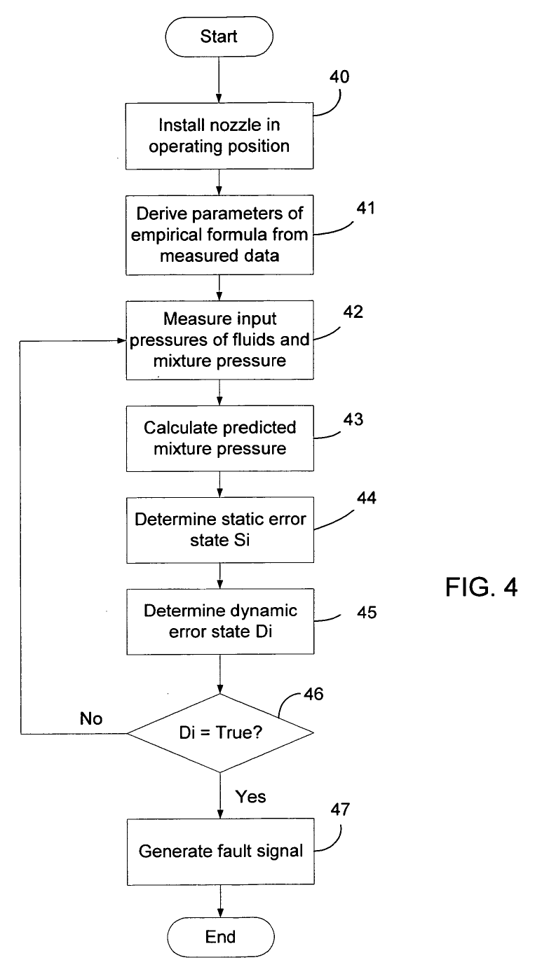

The process of setting up the spraying device 10 and the controller 20 and the subsequent monitoring operation are summarized in the flowchart in FIG. 4. First, the spraying device is set up in its intended operating position (step 40). A learning process is then performed under the control of the controller to determine the parameters in the empirical formula to be used for predicting the mixture pressure (step 41). Thereafter, during the normal operations of the spraying device, the controller continuously monitors the performance. For each detection cycle, the controller receives measured pressure signals for the input liquids and the mixture from the pressure sensors (step 42). The controller uses the measured input liquid pressures as inputs for the empirical formula to calculate the predicted mixture pressure (step 43). A static error state Sᵢ for the detection cycle is determined based on the measured and calculated pressure values (step 44). A dynamic error state Dᵢ is then calculated based on the present and past values of the static error state variable (step 45). If the dynamic error state Dᵢ is true (step 46), the controller generates a fault signal indicating that the spraying device is not functioning properly (step 47).

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A method for monitoring performance of a spraying device receiving at least first and second fluids and generating a spray of a mixture of said at least first and second fluids, comprising:
measuring an actual pressure of a mixture of the first and second fluids formed in the spraying device;
measuring a first input pressure for the first liquid and a second input pressure for the second liquid entering the spraying device;
calculating a predicted pressure for the mixture from the fist and second input pressures based on an empirical formula; and
determining, based on a comparison process using the predicted pressure and actual pressure of the mixture, whether the spraying device is functioning properly.

2. A method as in claim 1, wherein the first fluid is air and the second fluid is water.

3. A method as in claim 1, wherein the step of measuring the actual pressure of the mixture includes obtaining a reading from a pressure sensor mounted on the spraying device.

4. A method as in claim 1, wherein the empirical formula is a linear equation including empirically derived parameters.

5. A method as in claim 1, wherein the step of determining includes deriving a static error state based on a deviation of the actual pressure of the mixture form the predicted pressure, and deriving a dynamic error state based on values of the static error state over a pre-selected time period.

6. A method as in claim 1, further including the step of deriving parameters of the empirical formula from measured values of the first and second input pressures and the actual pressure of the mixture.

7. A method as in claim 6, wherein the step of driving includes performing a recursive least square analysis to fit the measured values of the first and second input pressures and the actual pressure of the mixture to the empirical formula.

8. A spraying system comprising:
a spraying device having at least a first inlet for a first fluid and a second inlet for a second fluid, an internal mixing chamber for mixing the first and second fluids to form a mixture inside the spraying device, and a nozzle end having an aperture for discharging the mixture to form a spray;
a mixture sensor coupled to the spraying device for measuring an actual mixture pressure of the mixture in the spraying device;
a first input sensor for measuring a pressure of the first fluid entering the spraying device;
a second input sensor for measuring a pressure of the second fluid entering the spraying device;
a controller for monitoring performance of the spraying device, the controller being connected to the mixture sensor and first and second input sensors for receiving readings indicative of measured pressures of the mixture and the first and second fluids, the controller being programmed to calculate a predicted mixture pressure from the measured pressures of the first and second fluids based on an empirical formula and to perform a comparison process using the predicted mixture pressure and the actual mixture pressure to determine whether the spraying device is functioning properly.

9. A spraying system as in claim 8, wherein the mixture sensor in mounted on the spraying device.

10. A spraying system as in claim 8, wherein the first fluid is air and the second fluid is water.

11. A spraying system as in claim 8, wherein the empirical formula is a linear equation including empirically derived parameters.

12. A spraying system as in claim 11, wherein the controller is further programmed to derive the parameters of the empirical formula from measured values of the first and second input pressures and the actual mixture pressure.

13. A spraying system as in claim 12, wherein the comparison process performed by the controller includes deriving a static error state based on a deviation of the actual mixture pressure from the predicted mixture pressure, and deriving a dynamic error state based on values of the static error state over a pre-selected time period.

14. A spraying device comprising:
a first inlet for receiving a first fluid;
a second inlet for receiving a second fluid;
a mixing chamber in which the first and second fluids are mixed to form a mixture;
a nozzle end having an aperture for discharging the mixture to form a spray; and
a pressure sensor mounted on the spraying device and disposed to sense a pressure of the mixture.

15. A spraying device as in claim 14, including a tube connecting the mixing chamber to the nozzle end, wherein the pressure sensor is mounted on the tube.
